(19) United States
(12) Patent Application Publication
(10) Pub. No.: US 2012/0131848 A1
(43) Pub. Date: May 31, 2012

(54) Vineyard Stake

(75) Inventor: Raimund Reisacher, Limburgerhof (DE)

(73) Assignee: DR. REISACHER WINZERBEDARF GMBH, NEUHAUSEN AUF DEN FILDERN (DE)

(21) Appl. No.: 13/386,823

(22) PCT Filed: Jul. 16, 2010
(86) PCT No.: PCT/EP2010/004336

§ 371 Date: Feb. 15, 2012

(30) Foreign Application Priority Data
Jul. 24, 2009 (DE) 10 2009 034 661.9

(51) Int. Cl. A01G 17/14; B21D 13/00

(52) U.S. Cl. 47/47; 72/379.6

(57) ABSTRACT

A stake for wine- and fruit-growing purposes has at least one hook for retaining a wire. The stake has a basic body with at least one limb made of sheet metal. The hook is a tongue portion, extending from a tongue base to a free end, punched and bent out of the sheet metal. An outer edge of the tongue portion, at an accommodating portion for the wire, is provided with a chamfer. The chamfer is obtained by introducing a first and a second groove, corresponding in shape to the contour of the tongue portion and being in particular V-shaped in cross section, into the basic body and then pressing the tongue portion out of the basic body.

The invention relates to a vineyard stake according to the preamble of claim 1.

Wire frames used in the wine- and fruit-growing industry are known to employ open or closed metal profiles having external hooks on their legs that are formed by punching tongue-shaped portions out of the base material and shaping said portions by bending.

Such metal profiles—which will also be referred to below as vineyard stakes—are known from DE 44 36 936 C2, for example.

The problem encountered with the metal profile described in the aforementioned document is that the tongue-shaped portions are subject to punching burrs for technical reasons, which means that the wires are unable to slide unrestricted in the receiving portions produced by bending the tongue-shaped portions; alternatively, the surfaces of the wires, which are frequently provided with a protective sheathing, are damaged by the punching burrs, with the result that the wires oxidize prematurely.

DE 10 2004 007 470 A1 describes a vineyard stake of the initially mentioned type in which, after being punched out, the tongue-shaped portions are bent over in the rearward direction away from the punched opening to form a C-shaped receiving portion, and are subsequently provided with a chamfer by pressing so as to allow the wires to slide freely, where possible, in the C-shaped receiving portions. Although the stakes described allow the wires to slide freely, the manufacture thereof is very complicated and time-consuming, since the subsequent incorporation of the chamfers is associated with an additional work step which increases the tooling costs and prolongs the overall manufacturing time by more than 30%. Moreover, the document gives no indication of also providing the outer sides of the C-shaped receiving portions for the wires with a chamfer in order to eliminate the punching burrs in these regions as well. These punching burrs on the outer side of the C-shaped portions can easily inflict unpleasant cut injuries on the harvesting personnel during manual grape harvesting and significantly increase the wear on the beater bars customarily employed on pick-up loaders for automatic grape harvesting.

Accordingly, it is an object of the present invention to provide a stake of the initially mentioned type and a method for producing same in which manufacturing-related punching burrs on the receiving portions are avoided in a cost-effective manner.

This object is achieved according to the invention by the features of claims 1 and 7.

Further features are described in the subclaims.

According to the invention, a stake for retaining a wire in the wine- and fruit-growing industry has a basic body with at least one leg which is made of metal sheet, for example steel sheet, and on which a hook is produced by punching and bending out of the metal sheet a tongue-shaped portion which extends from a tongue base toward a free end. The punched edge of the tongue-shaped portion that results during the punching operation is provided with a chamfer in the region of an in particular C-shaped receiving portion for the wire, this chamfer being produced according to the invention by a procedure in which a first and second groove which correspond in shape to the contour of the tongue-shaped portion are incorporated, in particular stamped, into the basic body from both sides of the basic body. After incorporating the two grooves, which are arranged in the metal sheet so as to lie one above the other and which each have in particular a substantially V-shaped cross-sectional shape, the tongue-shaped portion is pressed out of the basic body. Here, the material web, which remains between the base of the first groove and the base of the second groove and which, in the case of a metal sheet having a thickness of 1.5 mm, has only a thickness of, for example, 0.1 to 0.5 mm, is broken through with little expenditure of force, owing to its very low strength, when the tongue-shaped portion is pressed out of the basic body to form the receiving portion.

The vineyard stake according to the invention has the advantage that the chamfers on the tongue-shaped portion can be incorporated into the tongue-shaped portion without an additional time-consuming work step and also without the use of high-precision punching tools as are used, in particular, for the precision punching of metal sheets. A particular advantage here is that the use of the method according to the invention makes it possible as it were for two chamfers to be produced simultaneously and automatically on both sides of the tongue-shaped portion without a further work step being required for this purpose.

In the preferred embodiment of the invention, the receiving portion has a substantially C-shaped cross section which—proceeding from the tongue base—is bent away in the rearward direction from the resulting punched opening by more than 90°, preferably by more than 180°, such that the receiving portion extends virtually completely outside the punched opening. The advantage achieved thereby is that the receiving portion has a comparatively high degree of stiffness, with the result that it is virtually not deformed by the beater bars of pick-up loaders. Nor is there any risk with this embodiment of the invention that the tongue-shaped portion will be pressed back into the punched opening by the beating action of the beater bars of pick-up loaders.

The chamfer preferably extends from a first side of the receiving portion that faces the wire at a first angle of, in particular, 45° in the direction of a second side of the tongue-shaped portion that faces away from the wire. Here, the angle of the chamfer, i.e. of the surface which extends with an inclination to the inner surface of the tongue-shaped portion along the edge thereof, is defined by the angle which the associated legs of the V-shaped groove enclose with the inner surface of the tongue-shaped portion.

In the preferred embodiment of the invention, the peripheral edge of the tongue-shaped portion is provided with a further chamfer which extends from the second side of the receiving portion at a second angle of, preferably likewise, 45° in the direction of the first side of the tongue-shaped portion, i.e. in the case of the bent-back hook in the direction toward the inner surface of the receiving portion. Although the first and the second angle may also have different sizes, with the sum of the angles essentially always amounting to 90°, the advantage provided by a first and second angle each in the region of 45° is that the material web extends substantially in the region of the center plane of the tongue-shaped portion, with the result that the depth of each of the two V-shaped grooves, and hence the material deformation required to incorporate the grooves, is minimal. Moreover, the arrangement according to the invention of the peripheral material web in the region of the center plane of the tongue-shaped portion provides the further advantage that the web is situated at substantially the same distance both from the inner surface and from the outer surface of the receiving portion. This ensures that, on the one hand, the wire can slide freely along the surface of the chamfer without coming into contact with the web and, on the other hand, the material web is likewise arranged outside of the impact plane of the beater bars of pick-up loaders, said plane in this case being defined by the tangent between the external surface of the receiving portion and the vertically extending edge of the basic body of the vineyard stake.

The provision of a material web according to the invention which separates the two surfaces of the chamfers affords the further advantage that, when the tongue-shaped portion is being pressed out, a well-defined tear-off edge is produced which allows the tongue-shaped portion to be pressed progressively out of the basic body starting from the free end of said portion, which means that, given the resulting shearing action between the surfaces of the first and second chamfers, the force which is required to press out the portion is reduced once again in an advantageous manner.

According to a further idea on which the invention is based, the tongue-shaped aperture can be produced by punching out of the basic body a U-shaped portion. Here, the resulting U-shaped punchout, which preferably has a width which corresponds in particular to the thickness of the metal sheet, can be obtained by simultaneously incorporating into the metal sheet two grooves, spaced apart, for example, by 1.5 mm or 2 mm, on the upper side and lower side, i.e. a total of four preferably substantially V-shaped grooves situated opposite one another in pairs. Incorporating a U-shaped cut-out portion—or in other words a U-shaped clearance around the tongue-shaped portion-, affords the advantage that more space is provided around the tongue-shaped portion for the use of stamping tools which will be used, subsequent to the above-described punching operation according to the invention, to bring the tongue-shaped portion into its desired shape. In particular, for example, it is possible to carry out an additional stamping operation during the forming operation on the tongue-shaped portion so that, if desired, the remaining material webs are additionally removed from the hooks should they be considered to be problematic when using the stake according to the invention.

According to a further idea on which the invention is based, a method for producing a stake according to the invention comprises incorporating into the first side of the metal sheet a first groove which corresponds to the shape of the tongue-shaped portion and which has an in particular V-shaped cross-sectional shape, and incorporating into the second side of the metal sheet, which is on the opposite side to the first side of the metal sheet, a second groove which corresponds to the shape of the tongue-shaped portion and which has an in particular likewise V-shaped cross-sectional shape, such that the first and second groove are arranged in the metal sheet so as to lie substantially congruently one above the other. Subsequently, an additional force is applied to the tongue-shaped portion thus produced, for example as a result of a further displacement or movement of the stamping tool which produces one of the two grooves, this force pressing the tongue-shaped portion out of the metal sheet. Finally, the tongue-shaped portion pressed out of the metal sheet is subjected to a forming operation, preferably a cold-forming operation, in one or more subsequent forming steps in order to form an in particular C-shaped receiving portion for the wire on the tongue-shaped portion.

The forming operation advantageously proceeds here with the use of one, or preferably more, stamping tools which act successively on the tongue-shaped portion and which deform said portion in a direction perpendicular to the outer surface of the leg and in a direction parallel thereto while the metal sheet is being profiled to form the actual stake.

The invention will be described below by way of preferred embodiments with reference to the drawings, in which:

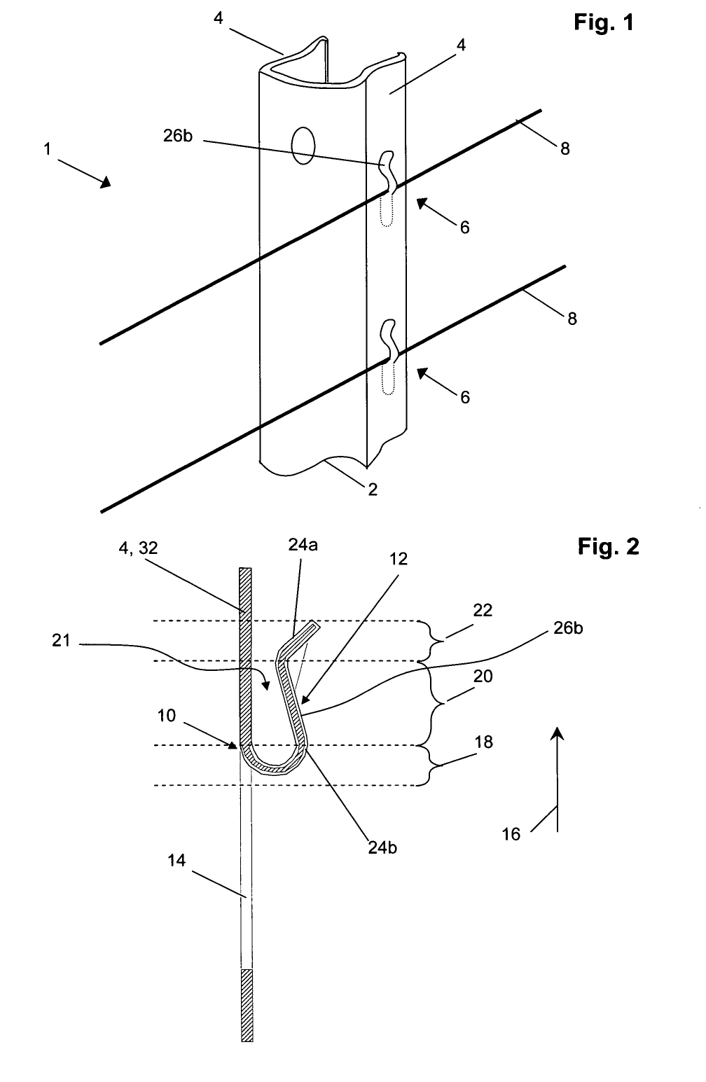

FIG. 1 shows a schematic three-dimensional illustration of a vineyard stake according to the invention,

FIG. 2 shows a schematic three-dimensional side view of a preferred embodiment of a bent-back hook having an S-shaped cross-sectional shape,

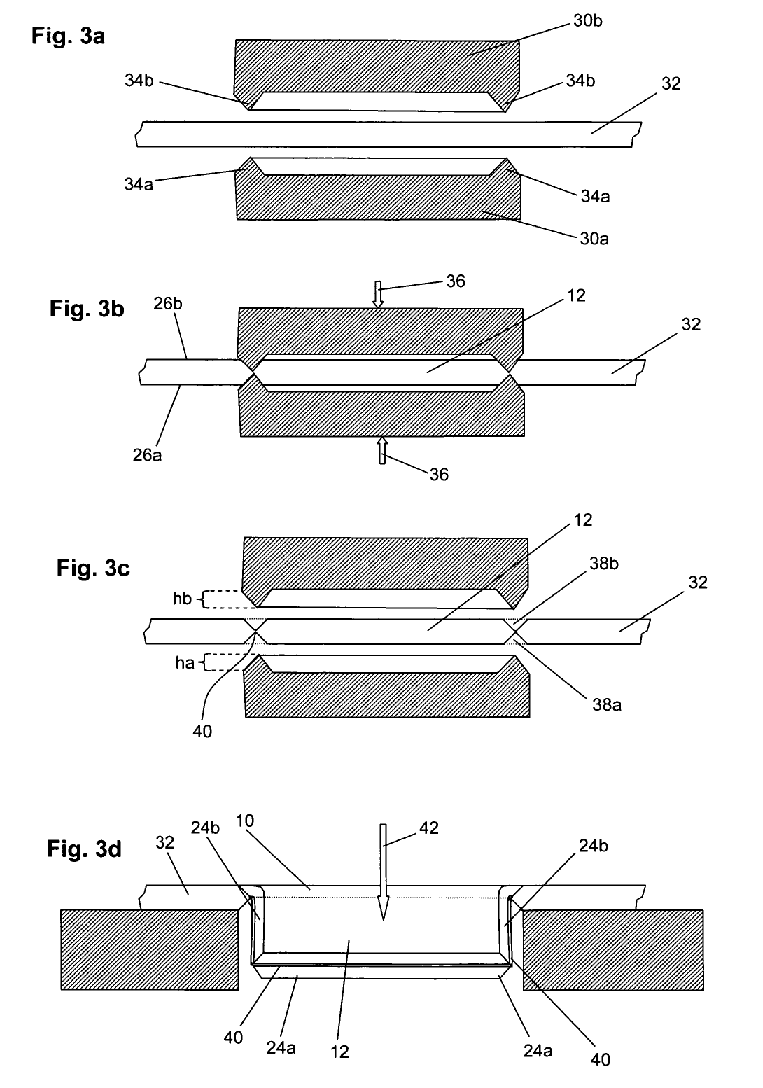

FIG. 3a shows a cross-sectional view through the metal sheet used for producing the vineyard stake according to the invention together with a stamping tool, likewise schematically indicated, on the upper and lower side prior to incorporating the V-shaped grooves,

FIG. 3b shows the cross-sectional view of FIG. 3a after the two stamping tools have been pressed into the metal sheet,

FIG. 3c shows the cross-sectional illustration of FIG. 3b after the two stamping tools have been moved apart,

FIG. 3d shows a schematic cross-sectional view through the tongue-shaped portion after the latter has been pressed out of the metal sheet,

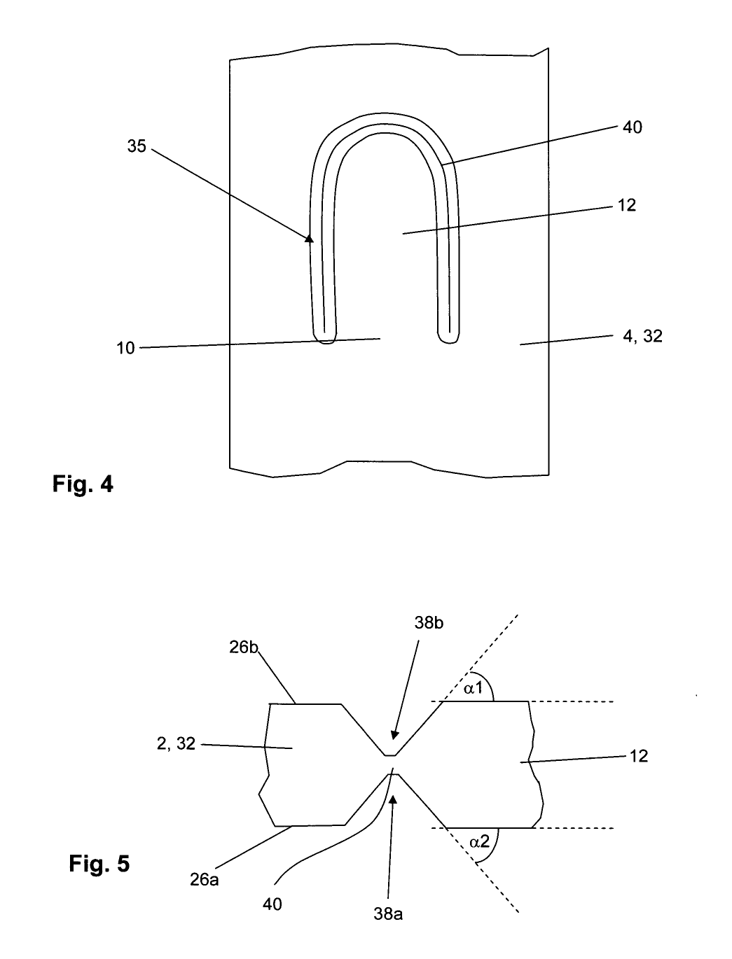

FIG. 4 shows a schematic plan view of the tongue-shaped portion defined in the metal sheet by impressing the first and second V-shaped groove prior to said portion being pressed out,

FIG. 5 shows an enlarged cross-sectional view of the metal sheet in the region of the incorporated grooves,

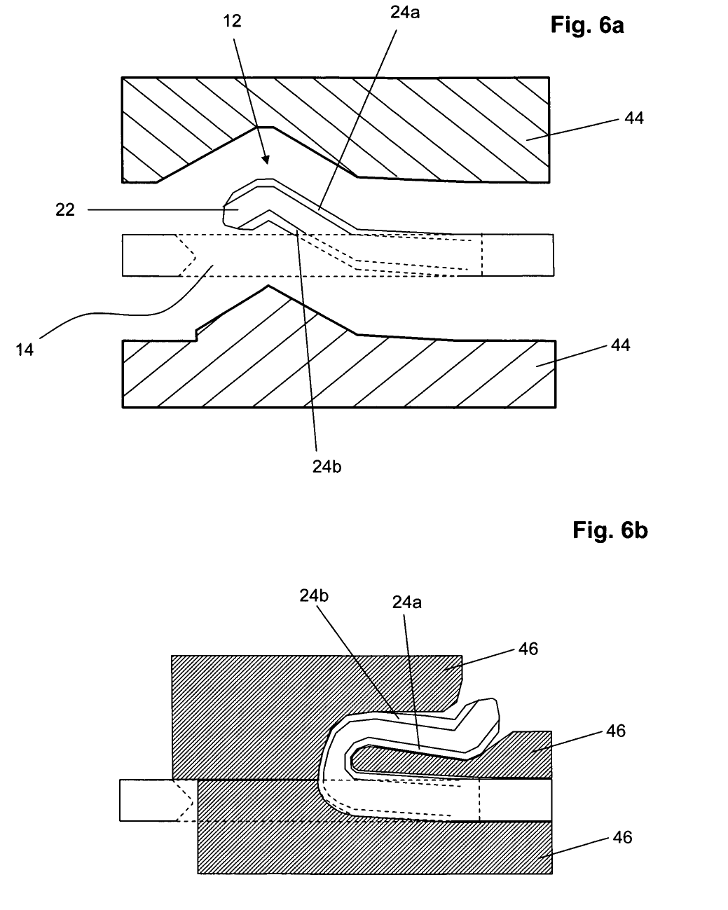

FIG. 6a shows a schematic cross-sectional view of the stamping tools for pressing out and deforming the tongue-shaped portion produced by the method according to the invention, with the chamfers formed thereon, and

FIG. 6b shows the tongue-shaped portion of FIG. 6a bent over in the rearward direction in a further method step, together with the stamping tools used for this purpose.

As is shown in FIG. 1, a vineyard stake 1 according to the invention comprises a basic body 2 formed from metal sheet 32, in particular from steel sheet, which has a substantially U-shaped cross section with legs 4 on which hooks 6 according to the invention for receiving wires 8 are formed.

As illustrated by FIG. 2, the hooks 6 here are produced by punching and bending out of the metal sheet 32 a tongue-shaped portion 12 which extends from a tongue base 10 toward a free end, the details of which procedure will be discussed more fully below in conjunction with FIGS. 3a to 3d. As illustrated by FIG. 2, the tongue-shaped portion 12 has a receiving portion 18 which is bent from the resulting punched opening 14 in the rearward direction depicted by the arrow 16 and which is of C-shaped design in the embodiment shown in FIG. 2.

Furthermore, the C-shaped receiving portion 18 is adjoined by a preferably rectilinear guide portion 20 which runs in the direction of the outer surface of the leg 4 and on the end of which can be formed an end portion 22 which extends away from the outer surface of the leg 4 and which facilitates insertion of the wire through the insertion opening 21.

In order to allow a wire 8 to slide freely after it has been hooked into the receiving portion 18, the tongue-shaped portion 12 is provided, in the region of its punched edge, with a chamfer 24a, 24b which is obtained when punching out the tongue-shaped portion in the manner shown in FIGS. 3a to 3d.

For this purpose, as shown in illustration 3a, a first and a second stamping tool 30a, 30b are pressed against the preferably planar metal sheet 32 from the lower side 26a and the upper side 26b. Here, the first, and preferably also second, stamping tool 30a, 30b have a peripheral projection 34a, 34b of triangular cross section which, as illustrated by FIG. 4, extends in a U shape along the tongue-shaped portion 12 and which has a height hₐ and h_{b} which preferably corresponds substantially to half the material thickness of the metal sheet 32.

Here, the projection 34a and the projection 34b of the first and second stamping tool 30a, 30b, respectively, preferably extend directly opposite one another along the outer edge of the tongue-shaped portion 12, as is indicated in the plan view in FIG. 4.

As is shown in FIG. 3b, the two stamping tools are pressed toward one another into the metal sheet 32 in a known manner by applying a pressing force, which is indicated by the arrows 36, to the two said stamping tools, with the result that the material of the metal sheet 32 is cold-worked in the region of the projections 34a, 34b such that, after withdrawing the first and second stamping tool 30a, 30b as shown in FIG. 3c, a U-shaped first and second groove 38a, 38b, which are preferably separated from one another in the region of the center plane of the metal sheet 32 by a material web 40, are formed on the lower side 26a and on the upper side 26b of the metal sheet 32.

Although the first and the second groove 38a, 38b are preferably impressed from both sides into the metal sheet 32 and thus have substantially the same identical V shape, it is also possible, if appropriate, for the V shape of the grooves to be chosen to be different on the lower side 26a and the upper side 26b of the metal sheet 32.

As is further shown in the illustration of FIG. 5, the first chamfer 24a, which is arranged in the region of the inner side of the receiving portion 18 when the hook 6 is finally bent, extends from the inner surface 26a of the receiving portion that faces away from the wire—which will also be referred to below as the first side—at a first angle α1 of in particular 45° in the direction of the opposite outer surface 28b of the tongue-shaped portion 12, which will also be referred to below as the second side facing away from the wire 8. Here, the angle of the chamfer, i.e. of the surface which extends with an inclination to the inner surface 26a of the tongue-shaped portion 12 along the outer edge 35 thereof, is defined by the angle which the associated legs of the V-shaped groove enclose with the inner surface of the tongue-shaped portion.

Similarly, in the preferred embodiment of the invention, the peripheral outer edge 35 of the tongue-shaped portion 12 is provided with the second chamfer 24b, which extends from the outer surface 26b of the receiving portion 18—which will also be referred to below as the second side—at a second angle α2 of preferably likewise 45° in the direction of the second side of the tongue-shaped portion 12, which, in the case of the bent-back hook 6 shown in the illustrations, forms the inner surface 26a of the receiving portion 18. Although well-defined angles α1 and α2 are depicted in the drawings between the surface of the chamfers 24a and 24b, it is possible, by suitably shaping the respective stamping surfaces of the first and/or second stamping tool 30a, 30b, for the transition region between the surfaces 26a, 26b and the associated aperture 24a, 24b also to have, if desired, a radius (not shown in more detail) of, for example, 0.1 to 0.5 mm or even more.

To produce the stake 1 according to the invention, and as described above in conjunction with FIGS. 3a to 3c, the preferably planar metal sheet 32 has stamped therein a first and second groove 38a and 38b having the V-shaped cross-sectional shape shown in detail in FIG. 5, these grooves being stamped into the first and second side 26a of the metal sheet 32 so as to lie substantially congruently and one above the other. The material web 40, which remains in the region of the respective groove base and which, in the case of a metal sheet 32 having a conventional thickness of 1.5 mm, has, for example, only a thickness in the region of 0.2 mm and a width of, for example, 0.5 mm, is then ruptured by once again applying a pressing force, indicated by the arrow 42, to the tongue-shaped portion 12 when the tongue-shaped portion 12 is pressed out of the metal sheet 32, as is indicated in FIG. 3d. Here, the tongue-shaped portion 12 can be pressed out of the metal sheet 32 by means of a further stamping tool 44, shown for example in FIG. 6a, which also forms a first part of the receiving portion 18 and also the end portion 22 while simultaneously pressing the tongue-shaped portion 12 out of the punched opening 14.

Finally, the tongue-shaped portion 12 pressed out of the metal sheet 32 is subjected to a forming operation, preferably a cold-forming operation, in a further forming step, shown in FIG. 6b, using one or more further suitable stamping tools 46 in order to form an in particular C-shaped receiving portion 18 for the wire 8 on the tongue-shaped portion.

### LIST OF REFERENCE SIGNS

1 Vineyard stake
2 Basic body
4 Leg
4 Hook
6 Wire
8 Tongue base
10 Tongue-shaped portion
12 Punched opening
14 Arrow
16 Receiving portion
18 Guide portion
20 Insertion opening
21 End portion
24a Chamfer in the region of the inner side of the receiving portion
24b Chamfer in the region of the outer side of the receiving portion
26a Lower side of the metal sheet/inner surface of the receiving portion
26b Upper side of the metal sheet/outer surface of the receiving portion
30a First stamping tool
30b Second stamping tool
32 Metal sheet
34a First U-shaped projection
34b Second U-shaped projection
35 Outer edge of the tongue-shaped portion
36 Arrow
38a First U-shaped groove
38b Second U-shaped groove
40 Material web
42 Arrow
44 Stamping tool
46 Stamping tool
α1 Angle
α2 Angle
ha Height of the first projection
hb Height of the second projection

1-8. (canceled)

9. A stake for wine and fruit growing, the stake comprising:
a basic body with at least one leg made of sheet metal and carrying at least one hook for retaining a wire;
said at least one hook being produced by punching and bending out of the metal sheet a tongue portion extending from a tongue base toward a free end, said tongue portion having a receiving portion for the wire formed with a chamfer;
said chamfer being formed by incorporating into the basic body first and second grooves corresponding in shape to a contour of said tongue portion and pressing the tongue portion out of the basic body.

10. The stake according to claim 9, wherein said first and second grooves have a V-shaped cross-sectional shape.

11. The stake according to claim 9, wherein said receiving portion has a substantially C-shaped cross section and is rearwardly bent, proceeding from said tongue base, by more than 90°, such that said receiving portion extends substantially outside the punched opening over said leg of said basic body.

12. The stake according to claim 11, wherein said receiving portion is bent by more than 180°.

13. The stake according to claim 9, wherein said chamfer extends from a first side of said receiving portion facing the wire at a given angle in a direction of a second side of said receiving portion away from the wire.

14. The stake according to claim 13, wherein said given angle is a 45° angle.

15. The stake according to claim 13, wherein said receiving portion is formed with a further chamfer extending from the second side of said receiving portion at a chamfer angle in a direction of said first side of said receiving portion.

16. The stake according to claim 15, wherein said chamfer angle is a 45° angle.

17. The stake according to claim 15, wherein surfaces forming said chamfers are separated from one another by a material web.

18. The stake according to claim 9, wherein a tongue-shaped aperture is formed in said metal sheet by punching out of said basic body a U-shaped portion having a width corresponding in particular to a thickness of said metal sheet.

19. A method of producing a stake for wine-growing and fruit-growing industrial use, the method comprising:
providing a basic body for the stake formed with at least one leg made of sheet metal;
forming into a first side of the metal sheet a first groove corresponding to a shape of the tongue portion;
forming into a second side of the metal sheet, which is on a side opposite from the first side of the metal sheet, a second groove corresponding to the shape of the tongue portion, with the resulting first and second grooves being formed in the metal sheet lying substantially congruently one above the other;
applying a force to the tongue portion sufficient to cause the tongue portion to be pressed out of the metal sheet; and
forming the tongue portion into a receiving portion for a wire, with the tongue portion forming a hook configured for retaining the wire to the stake, the tongue portion extending from a tongue base toward a free end, and the tongue portion being formed with a chamfer.

20. The method according to claim 19, which comprises forming the stake according to claim 9.

21. The method according to claim 19, which comprises forming one or both of the first groove and the second groove with a V-shaped cross-sectional shape.

22. The method according to claim 19, which comprises shaping the tongue portion by way of a plurality of stamping tools acting successively on the tongue portion in a direction perpendicular to an outer surface of the basic body and/or in a direction parallel thereto.
